(19) United States
(12) Patent Application Publication
(10) Pub. No.: US 2012/0237909 A1
(43) Pub. Date: Sep. 20, 2012

(54) Method for treating fears and anxieties of abused persons by using virtual, simulated retaliation

(76) Inventor: Richard H. Stern, Washington, DC (US)

(21) Appl. No.: 13/442,696

(22) Filed: Apr. 9, 2012

Related U.S. Application Data
(62) Division of application No. 11/166,991, filed on Jun. 27, 2005.

(51) Int. Cl. G09B 19/00

(52) U.S. Cl. 434/236

(57) ABSTRACT

This method provides a way for a user to alleviate feelings of fear, anxiety, helplessness, powerlessness, vulnerability, or other negative feelings that the user has toward another person with whom the user previously had an abusive relationship. Images of the other person and a deadly weapon, such as a knife or axe, are displayed. The user moves the images so that the weapon appears to harm the other person. Unless the negative feelings of the user are ascertained to be reduced by a predetermined amount, the process is repeated. The procedure thus transforms the user in a manner such that at least partial catharsis or discharge of negative cathexis occurs, but without the user believing consciously that the user's simulated actions actually harmed the other person as acted out. A preferred embodiment carries out this procedure by computer means, such as a PC or handheld portable device.

### CROSS-REFERENCE TO RELATED APPLICATIONS

This application is a divisional of Applicant's Ser. No. 11/166,991 entitled Mental Therapy Method for Catharsis of Negative Feelings filed in the U.S. Patent & Trademark Office on 27 Jun. 2005.

### BACKGROUND OF THE INVENTION

1. Technical Field

The present application relates generally to a method for treating a victim of abuse to provide relief of fear, anger, resentment, and negative feelings by providing a cathartic outlet for them. More specifically, the object and purpose of the invention is to provide an amount of therapy or treatment, for a patient desiring such treatment, as will cause a reduction in the patient's level of feelings of fear, anxiety, helplessness, powerlessness, or vulnerability, which is measurable by a decrease in physiological parameters of the patient's body such as blood pressure, pulse rate, respiration rate, or sweat rate, which a therapist or the patient may observe directly or by an apparatus. Specific applications of the invention include use of the method for treating victims of spousal abuse and victimized AIDS patients.

2. Related Art

The existence of the processes of catharsis and discharge of cathexis have long been known, although their specific mechanisms may be disputed. Catharsis, for present purposes, may be defined as it is in The American Heritage Dictionary of the English Language, Fourth Edition: 1. Medicine. Purgation, . . . . 2. A purifying or figurative cleansing of the emotions, especially pity and fear, described by Aristotle as an effect of tragic drama on its audience. 3. A release of emotional tension, as after an overwhelming experience, that restores or refreshes the spirit. 4. Psychology. a. A technique used to relieve tension and anxiety by bringing repressed feelings and fears to consciousness. b. The therapeutic result of this process; abreaction. A shorter but similar definition is found in The American Heritage Stedman's Medical Dictionary—“1. Purgation. 2. A psychological technique used to relieve tension and anxiety by bringing repressed feelings and fears to consciousness. 3. The therapeutic result of this process; abreaction.” Cathexis, for present purposes, may be defined as it is in The American Heritage Dictionary of the English Language—“Concentration of emotional energy on an object or idea.” A negative cathexis, therefore, is a concentration of negative emotional energy on an object or idea, and in particular in the context of this invention a concentration of negative emotional energy on a specific person, such as anger, anxiety, or fear directed to an estranged spouse or lover, or other person with whom adverse interpersonal interactions have occurred. In catharsis or in discharge of negative cathexis, a person decreases or relieves anger, anxiety, fear, hostility, or other negative feelings or discharges a concentration of negative emotional energy, by doing or participating in activities which may include a method of therapy, in particular, psychotherapy.

Discharge of cathexis, as used herein, is to be distinguished from anticathexis, which is considered to be related to the very investment of emotion that the invention is, among other things, intended to dissipate or lessen. (Anticathexis is investment of energy in repression of negative feelings instead of bringing them out into the open and discharging them.) Discharge of negative cathexis, as that term is used herein, is also to be distinguished from decathexis. That term usually refers to a slow diminishment of a positive cathexis, as occurs in mourning over the death of a loved one and in detachment from a once-valued relationship. See generally S. Freud, Mourning and Melancholia (1917).

Negative cathexis causes stress and is harmful to the person having or subject to it. Stress can lead to medical problems such as ulcers, acute gastritis and diarrhea. Onsets of erythrocytosis, inflammatory bowel disease, heart attacks and ischemia are influenced by stress. In fact, there is clinical evidence that psychic or emotional stress and anxiety are associated with precipitation of overt ischemic heart diseases and sudden death. See E. D. Eaker, et al., “Anger and Hostility Predict the Development of Atrial Fibrillation in Men in the Framingham Offspring Study,” Circulation, 2004:109(10):1267-1271 (available online at http://circ.ahajournals.org/cgi/content/full/109/10/1267 and http://circ.ahajournals.org/cgi/reprint/109/10/1267);J. E. Williams, et al., “The Association Between Trait Anger and Incident Stroke Risk: The Atherosclerosis Risk in Communities (ARIC) Study,” Stroke, 2002: 33(1):13-20 (available online at http://stroke.ahajournals.org/cgi/reprint/33/1/13); J. E. Williams, et al., “Anger proneness predicts coronary heart disease risk: prospective analysis from the atherosclerosis risk in communities (ARIC) study,” Circulation, 2000:2034-2039 (available online at http://circ.ahajournals.org/cgi/content/full/101/17/2034); D. S. Krantz, et al., “Mental stress as a trigger of myocardial ischemia and infarction,” Cardiology Clinics 1996:14:271-287 (Abstract available online at http://www.ncbi.nlm.nih.gov/entrez/query.fcgi?cmd=Retrieve&db=PubMed&list_uids=8724559&dopt=Abstract); M. A. Mittleman, “Triggering of Acute Myocardial Infarction Onset by Episodes of Anger,” Circulation, 1995:92:1720-1725 (available online at http://circ.ahajournals.org/cgi/content/full/92/7/1720?ijkey=64b686e51a543f0fbe80110a52d0cab9cb59ba36). By the same token, elimination or lessening of the negative thoughts and feelings that cause such stress and their adverse physiological effects is a useful, concrete, and tangible result. See J. E. Muller, et al., “Mechanisms Precipitating Acute Cardiac Events,” Circulation, 1997:96:3233-39 (“It has been reported that anger is the predominant behavioral affect in the majority of patients who experience life-threatening arrhythmias. . . . [P]atients who are habitually angry can increase annual risk substantially and should be advised to seek appropriate counseling.”) (available online at http://circ.ahajournals.org/cgi/content/full/96/9/3233#SEC10).

It is known that victims of spousal abuse suffer stress induced by the abuse and feelings of fear, anger, helplessness, powerless, anxiety, loss of self esteem, and other negative feelings. See generally O. Barnett, et al., Family Violence Across the Lifespan—An Introduction, ch. 10, “Intimate Partner Violence: Abused Partners” (available online at http://www.sagepub.com/Barnett %20Chapter %20%2010_{—}5133.pdf) (collecting references). As used hereinafter, the term “negative feelings” includes feelings of fear, anger, helplessness, powerless, anxiety, and loss of self esteem, among others.

It is known that one form of anger-relieving cathartic activity or discharge of negative cathexis is sticking pins into dolls supposed by the user to represent a person toward whom the user has negative feelings. Thus, a person might want to stick pins into a doll simulating bin Laden, or in an earlier era Stalin or Hitler. Some persons apparently derive emotional benefits from sticking pins into dolls representative of football players from a team rival to the user's hometown team. See Bettendorf U.S. Pat. No. 6,663,462 (2003), “Aggression-Relieving Stuffed Doll.” This patent's specification asserts: “Sports fans often become quite agitated or even infuriated by the performance or antics of players on their favorite sports team or the opposing team. It is both entertaining and relieving for these sports fans to have an outlet by which to vent their emotion. Therefore, it would be desirable to have a stuffed doll that simulates a sports player into which sharp pins may be inserted.” This form of behavior relies on dolls or similar tangible physical objects, and has done so since ancient times. In this connection, actual assault and battery is, of course, illegal and is usually infeasible as a means of catharsis of fear and anger, for example, that caused by spousal abuse.

Moreover, while it may be feasible to mass-market dolls or simulacra of famous or widely known persons, such as bin Laden or Hitler, for use of the kind described above, a mass-marketable means for similarly addressing a user's anger, hostility, fear, or other negative feelings (i.e., discharging such cathexis) in regard to a former spouse or lover, personal rival, or other specific person well known to the user but not famous, well-known, or widely publicized to other persons is unavailable. For example, it is not possible for an ordinary person to find a simulacrum of an estranged spouse or lover in the marketplace, so that it can be used in this connection. To be sure, in Voodoo and other shamanistic practices, an appropriate doll or other physical simulacrum resembling the person who is the object of a user's fear or anger may be fabricated on an individual basis. But this is time-consuming and expensive, and it does not lend itself to a mass-marketable application. On the other hand, committing aggressive or simulated aggressive actions against an object that does not really closely resemble the actual person who is the object of the user's anger, fear, or similar negative cathexis is not very effective in bringing about catharsis or discharge of the cathexis for the user. It is believed that no inexpensive, mass-marketable expedient available at this time for achieving catharsis with respect to a specific, individual person toward whom a user has anger, fear, or other negative thoughts or feelings.

It would be desirable to provide an inexpensive, mass-marketable expedient for achieving catharsis with respect to a specific, individual person toward whom a user has anger, fear, or other negative thoughts or feelings, and/or for focusing and bringing out into the open such feelings so as to help dissipate them. Such an expedient should not be illegal as are actual assault and battery. It would also be desirable that the user not be required to believe consciously that the user's catharsis-providing actions do in fact cause physical harm to the object of the negative feelings, or that the object of the negative feelings need to be so persuaded either, as some shamanistic practices require. See D. Morse, et al., “Psychosomatically Induced Death: Relative to Stress, Hypnosis, Mind Control, and Voodoo: Review and Possible Mechanisms,” Stress Medicine 7:213-32 (1991). Those are shortcomings of traditional Voodoo or shamanistic practices that it would be desirable to avoid.

### SUMMARY OF THE INVENTION

This invention provides a way for a user (a first person) to alleviate fear, anger, or other negative thoughts or feelings that the user has toward a specific second person, who is personally known to the user and with whom the user has previously has adverse personal interactions, or to focus such anger or negative thoughts or feelings on the second person who is an object of the user's negative feelings. This is accomplished by having the user select and display an image of the second person, so that the image is visible to the user, and also select and display an image of an object that is potentially harmful to the second person. Then the user causes the displayed images to touch, become superimposed on, or located near one another. For example, an image of a knife is moved so that it appears that the knife stabs the image of the second person. It is then determined whether the fear, anger, or other negative thoughts or feelings of the user have been reduced. If not, the process is repeated. As a result, as in Voodoo and similar practices, the foregoing procedure transforms a state of mind of the user in a manner such that an at least partial catharsis or discharge of cathexis occurs, but without (as in Voodoo and similar practices) the user believing consciously that the user's simulated actions actually harm the second person in the manner acted out. A preferred embodiment utilizes computer means to carry out this procedure, such as a PC or handheld portable programmed device.

### BRIEF DESCRIPTION OF DRAWING

FIG. 1 is a block diagram of a computer system configured to carry out an embodiment of the invention.

### DETAILED DESCRIPTION OF THE INVENTION

A difficulty with readily available expedients for discharging negative feelings that the invention addresses and overcomes concerns the issue of lack of sufficient resemblance between the object of the user's negative feelings and the available object for discharging the negative feelings. For example, sticking pins into a bin Laden doll, or any generalized and undifferentiated object, is not helpful to an abused spouse in discharging her negative feelings toward the abusive spouse. The inventor considers that the insufficient resemblance between such a doll and the person against whom the user's feelings of fear and anger have been aroused (because of the latter's behavior toward the user) interferes with formation by the user of a sufficient association between such a doll and the abusive person. That in turn interferes with the needed linking between the user's symbolic acts of retaliation and the abusive person. The inventor considers that effective catharsis of the kind sought here can be provided to the user only by providing the user with a thing against which symbolic or simulated harmful actions are directed and which the user substantially associates with her abuser or other personal object of a negative cathexis. It is considered that this requires a substantial resemblance of the thing against which symbolic or simulated harmful actions are directed and the actual abusive person or other personal object of a negative cathexis, such as a visually perceived image of that person.

### Embodiment Using a Computer Screen Display

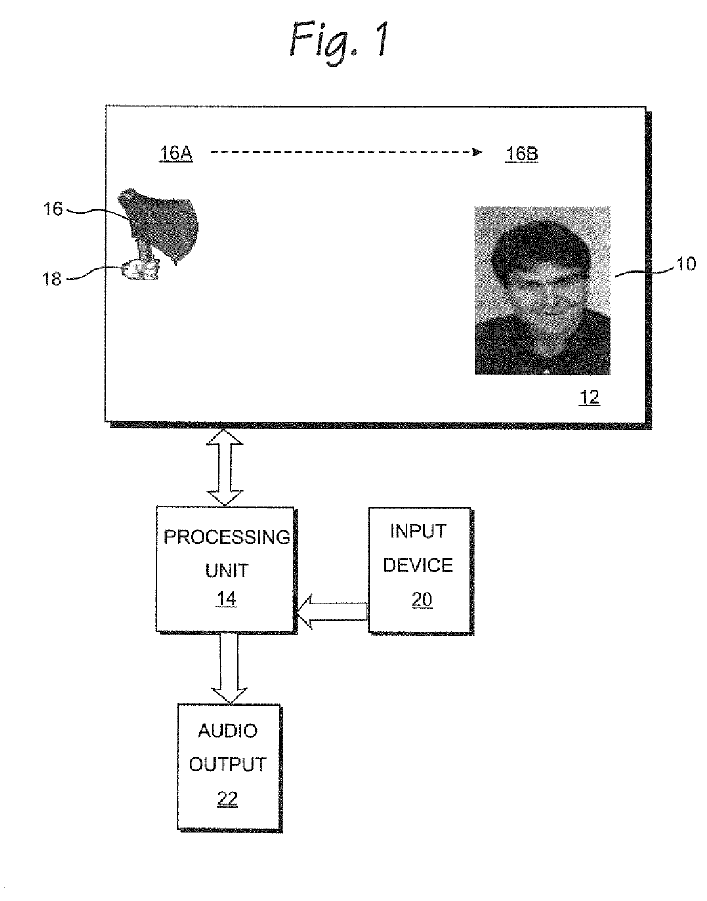

In an embodiment of the invention shown in FIG. 1, a user (first person) selects and causes an image 10 to be placed on a display device such as a computer screen display 12 that provides visual displays of images, using a computer program provided to the user by a vendor (directly or via the user's therapist). The computer program may advantageously be in the form of computer-readable code embodied in a CD and installed on the hard disk of the PC. Image 10 embodies a photograph of a second person (such as the user's estranged spouse), whom the user has known personally and toward whom the user has anger or other negative thoughts or feelings because of the first and second persons' prior adverse interpersonal interactions. Image 10 may advantageously be a jpeg, such as one derived from a digital camera photograph of the second person. Other forms of graphics files can advantageously be used instead. For example, a gif of a drawing can be utilized, as can a bmp, png, or other graphics format.

Computer screen display 12 is operatively coupled to a processing unit 14, which is preferably a personal computer (PC) belonging to the user, or if the user is to receive therapy under the direct supervision of a therapist the PC is that of the therapist and is located in her office. Processing unit 14 can also be a microprocessor or microcontroller, if a special-purpose device is to be used instead of a PC. Thus, in a further embodiment the invention is implemented in a handheld, special-purpose, programmed microprocessor device, similar to a Palm Pilot, so that a user may carry it around with her.

A second image 16, embodied in a graphics file such as a jpeg or gif, is selected by the user and caused to be placed on screen display 12 at a first screen location 16A. Image 16 depicts a knife, sword, axe, hammer, whip, arrow, club, fist, stone, piece of broken glass, or other thing potentially harmful to the second person. For example, image 16 could depict a heap of toxic powder meant, for example, to simulate anthrax spores mixed with a carrier such as talc or the toxic powders made by skinwalkers in Southwestern Native American mythology or folklore.

Image 16 is then caused to move from its first screen location 16A to a second screen location 16B, as shown in FIG. 1 by a dashed arrow line. The motion is advantageously effected by the user's utilization of a cursor 18 (in cooperation with a mouse, trackball, joystick, keyboard, or similar input device 20 operatively coupled to processing unit 14) to drag the image. Dragging image 16 with a mouse is a preferred means for the user to translate or move image 16 from location 16A to 16B, but other means for effecting the motion are discussed hereinafter. In one implementation of the invention, images 10 and 16 are selected to be “objects” utilized by a Java applet that allows, for example, image 16 to be clicked on by the user, who then mouse-drags it from location 16A to 16B.

The motion is effected in a manner such that in screen position 16B the object that image 16 depicts appears to harm the second person. If image 16 is that of a knife or sword, it may be made to appear to penetrate the body of the second person. If image 16 is that of a club, it may be made to appear to hit the second person on the head. If image 16 is that of a heap of toxic powder, it may be made to appear to be very close to the nose of, and being inhaled by, the second person. If image 16 is that of pieces of broken glass, it may be moved by the cursor to appear to have been placed within the interior of the body of the second person. Other candidates for image 16 are axes, hammers, whips, arrows, chains, fists, and boots. Still further candidates for image 16 as potentially harmful objects will be apparent to skilled persons.

Audio output unit 22, which may be implemented with one, or more, speakers or by headphones, is driven by processing unit 14 in synchronization with one, or more, features or occurrences of the steps of the process of the invention displayed by screen 12, to enable at least one step to be either preceded, accompanied, or followed by an audible rendition of a phrase, mantra or incantation. The phrase, mantra or incantation may be selected with regard to helping the user overcome negative feelings caused by prior adverse interpersonal interactions between the user and a second person, which are believed to have precipitated the fear, anger, or negative thoughts or feelings of the user. This supplement to the process may contribute to a diminution of the fear, anger, or negative thoughts or feelings, or a reduction of the negative cathexis, in the user.

Audio output unit 22, which may be implemented with one or more speakers or by headphones, is driven by processing unit 14 while one or more steps of the process of the invention occur. This enables at least one step of the process to be preceded, accompanied, or followed by an audible rendition of a phrase, mantra or incantation. The phrase, mantra or incantation may be selected with regard to helping the user overcome negative feelings caused by prior adverse interpersonal interactions between the user and a second person, which are believed to have caused the fear, anger, or negative thoughts or feelings of the user. This supplement to the process may contribute to a diminution of the fear, anger, or negative thoughts or feelings, or a reduction of the negative cathexis, in the user.

Pursuant to 37 CFR §1.52(c)(2) and 37 CFR §1.77(b)(4), an electronic document bearing a file name of “Ax2Head.gif,” containing 136 kilobytes, having a date of creation of May 2, 2005, at 11:10 a.m., prepared in compliance with 37 CFR §1.52(e), that is filed simultaneously as a constituent part of this application with two (2) duplicate compact-disc read-only-memories (i.e., CD-ROMs) labeled as “Copy 1” and “Copy 2,” each containing a table formed by a sequence of images illustrating aspects of at least one embodiment in the practice of the present invention, with the contents of each disk formatted in Graphics Interchange Format (“gif”) files with all text set forth in compliance with the American Standard Code for Information Interchange (“ASCII”), is hereby incorporated into this application by reference. Pursuant to 37 CFR §1.52(g)(4), the two compact disks are identical. This file is an animation that conveniently illustrates aspects of an embodiment of the invention.

The embodiment initially described above is one in which the user uses a cursor 18 to move object 16 to object 10, from position 16A to position 16B. However, conventional computer programming expedients permit automatic motion of images 10 and 16 relative to one another without use of a cursor to effect the translation across the screen.

By engaging in the procedure described, and appropriately juxtaposing images 16 and 10, the user in effect commits mayhem on the second person in virtual, rather than actual, space. After one or more such acts of virtual mayhem, it is determined whether a desired cathartic effect has been realized, thereby substantially reducing the user's fear, anger, or negative thoughts or feelings, or bringing about at least a partial discharge of the negative cathexis. If not, the procedure is repeated. As used hereinabove, the term “substantially” means not insubstantially. That is, the determination is made as to whether more than a trivial or insignificant reduction occurred. The reduction should be at least enough to be perceptible, as distinguished from de minimis and imperceptible. The purpose is to bring about a therapeutically efficacious result, comparable to dispensing an effective dosage amount of a medication. In the absence of a standard set by an individual therapist for a specific patient, which is preferred and when available would supersede any rule of thumb, it is considered that 5% provides a rule of thumb for substantial versus insubstantial where a quantitative measurement is used, such as that described hereinafter for automatic machine monitoring of blood pressure.

Determination of Effect

Several different expedients are available for providing a way to determine whether the user has undergone a reduction of her fear, anger, or negative thoughts or feelings, or a reduction of or an at least partial discharge of her negative cathexis. The method of determination can be by suitable verbal interrogation, if a therapist is using the invention with a patient. Also, an individual user may self-interrogate herself in response to messages on a screen display, thereby providing a YES or NO signal which is fed to processing unit 14.

An individual user may also use any of a number of conventional electronic devices for determining reduction of stress by measuring a physiological parameter considered representative of stress, such as blood pressure, pulse rate, or palm-sweating. For example, blood pressure or pulse rate can be measured and monitored with many automatic measuring devices now on the market. The output of such a device is advantageously fed to processing unit 14, so that the process of the invention is repeated (for example, by using a conventional “while,” “do while,” or “do until” loop in the program) unless the device indicates an appropriate reduction of blood pressure or pulse rate (for example, 5%). (This portion of the system can be referred to as a determination unit. The “determination unit” can be hardware or software in a PC, as well as a combination of both.)

### Alternative Embodiments Regarding Motion of Images

In a preferred embodiment the user moves image 16 by using cursor 18 from position 16A distanced from image 10 to position 16B near, touching, or within image 10. For example, the user moves an image 16 of a stone or rock from one part of the screen across the screen, so that the stone appears to strike an image 10 of the head of the second person.

But instead the user could move an image 10 representative of the head of the second person across the screen so that it appears to strike against an image 16 of a stone or rock. This is a comparable expedient. Thus, depending on the effect desired and the harmful object involved, the user causes the images 10 and 16 to touch, become superimposed on, or located near one another, through the motion of one or the other, or both, images, in a manner such that the harmful object appears to harm the second person in, effectively, an act of virtual mayhem. (As used hereinafter, terminology such as “causing the image of the object to touch the image of the second person” means moving the object image to the person image, moving the person image to the object image, and/or any relative motion of the images by which the result is that they touch each other.)

Special Cursors

As already described, in a preferred embodiment the user effects motion by using a cursor 18 to drag an image across the screen. Cursor 18 on a PC screen display is ordinarily an arrow, but it need not be. It is considered preferable for purposes of this invention to use a cursor shaped like a hand, for example, as occurs in applications such as Adobe Acrobat. Even more advantageously, cursor 18 is displayed as an open hand until the user moves it over image 16 (which is, for example, an image of an ax) and clicks the mouse. The open hand cursor image is then replaced by a closed hand image that appears, for example, to clasp the handle of the ax. The user then drags image 16 to image 10, with the cursor/hand appearing to grasp the ax.

In another implementation, the cursor is reduced to a one-pixel square after clicking on object 16, so that when the object image (for example, a rock) is translated across the screen by the motion of the mouse, the moving image (rock) seems to be just an extension of the user's hand (which is on the moving mouse). These expedients increase the verisimilitude of the operation and are considered to enhance the user's feeling that he or she is personally performing or acting out the action depicted.

Such motion to translate image 16 from location 16A to location 16B can instead be effected in a predetermined manner by computer program means, without a cursor. This is described below.

Animation Effects

In a further embodiment image 16 is an animated graphics file (or what the copyright statute, see 17 U.S.C. §101, terms an audiovisual work). Thus if image 16 is that of a club, it may be programmed to show apparent motion of a club from a first position to a second position, for example, through a 90 degree rotation or a horizontal or vertical displacement. Then the club would appear in a first position to be somewhat distanced from the head of the second person and in a subsequent position appear to be contacting (striking) the head of the second person.

The animated graphics file could be programmed to loop indefinitely or a predetermined number of times, so that the second person appears to be repeatedly struck on the head with a rock or club. If image 16 is that of a knife, it may be programmed to show apparent motion of a knife from a first position to a second position, for example, through a horizontal or vertical displacement. Then the knife would appear in a first position to be somewhat distanced from the body of the second person and in a subsequent position to be penetrating the body of the second person. The animated graphics file could be programmed to loop indefinitely or a predetermined number of times, so that the second person appears to be repeatedly stabbed. If image 16 is that of a heap of toxic powder, it can be placed near the nose part of image 10. The successive frames of the animated graphics file would then depict the heap of powder changing from a heap to a cloud of particles that blows toward and into the nostrils of image 10.

It is considered preferable in the case of some users to require each animation performance from the first through last frames of the animated graphics file to be initiated by a prespecified volitional user action, such as a mouseclick or keystroke carried out by means of user input device 20, instead of automatically endlessly looping an animated graphics file. Whether impersonal commission of simulated mayhem (automatic initiation of the animation sequence) or requiring positive user involvement in actuating the simulated mayhem (i.e., by using a user actuated initiation means for each animation sequence) is more therapeutically efficacious may have to be determined empirically case by case. In some circumstances, the user's repeated act of pressing the return key or pressing a mouse button, thereby initiating a new animation sequence of a simulated stabbing or clubbing of the second person provides enhanced catharsis. The motor action by the user actualizes the user's feeling of personal causal involvement in the retribution event. Other users, perhaps more squeamish, may prefer to see the second person “get what he has coming” without need for their active intervention. It is advantageous, therefore, to include a design feature that permits operation in either of these modes at the user's option.

In a variation of these embodiments, use of an animated graphics file permits a simulation of blood to flow or drip from image as an apparent result of the hostile actions committed against it. A programming expedient that advantageously simulates blood flow is to superimpose image layers over the initial image of the second person, where the added image layers embody the blood flow. The inventor has placed, and made available on-line, on the Internet an illustrative animated gif using this technique—www.law.gwu.edu/facweb/claw/Ax2Head.gif. This gif shows an animation of FIG. 1 hereof, in which blood is shown flowing down the head of image 10, as an apparent result of the action of image 16 (an axe).

It is contemplated that relatively simple animation effects, such as that of the club or knife, can be provided as part of a vendor's standard CD-based product. More complex animation techniques, however, are likely to be more feasible with a service-bureau type of implementation, using the Internet.

Technology for implementing the foregoing expedients is well known to those skilled in the art of programming graphics, although at this time such technology does not appear to be used for therapy. Thus, expedients similar to those described in the preceding paragraph can be implemented by means of Java applets. An example of such Java programming, for purposes of entertainment or amusement, rather than for therapeutic alleviation of anger or anxiety with respect to a specifically known person such as a former spouse, is available on the Internet. See the Web page of Virtual Design Group, Inc. of Atlanta, Ga., at www.virtual-design.com/demos/voodoodoll/voodoo.asp?section=demo&subsection=voodoo. For example, most of the routines needed to implement the graphics for this invention are standard library features in Sun Microsystems' Java Software Development Kit 1.5. Alternatively, Flash could be used to create the visual animation.

While PC graphics have been described above, the same principle applies to other image creation or reproduction devices. These include, without limitation, projection on a wall or screen, Palm Pilot-like devices, holographic projection, and other holographic devices.

Pursuant to 37 CFR §1.52(c)(2) and 37 CFR §1.77(b)(4), an electronic document bearing a file name of “Ax2Head.gif,” containing 136 kilobytes, having a date of creation of May 2, 2005, at 11:10 a.m., prepared in compliance with 37 CFR §1.52(e), that is filed simultaneously as a constituent part of this application with two (2) duplicate compact-disc read-only-memories (i.e., CD-ROMs) labeled as “Copy 1” and “Copy 2,” each containing a table formed by a sequence of images illustrating aspects of at least one embodiment in the practice of the present invention, with the contents of each disc formatted in Graphics Interchange Format (“gif”) files with all text set forth in compliance with the American Standard Code for Information Interchange (”ASCII”), is hereby incorporated into this application by reference. Pursuant to 37 CFR §1.52(g)(4), the two compact disks are identical. This file is an animation that conveniently illustrates aspects of an embodiment of the invention. (The same file is also available at, and can be downloaded from www.law.gwu.edu/facweb/claw/Ax2Head.gif.)

### Internet-Implemented Embodiments

One aspect of the invention is how it is exploited commercially. As described previously, a vendor can exploit the invention, among other ways, by programming suitable computer-readable code onto a computer-readable medium (such as a CD) that the user can input into the user's PC or special-purpose programmed-microprocessor device. This approach essentially requires selling the CDs and/or special-purpose programmed-microprocessor devices to end users. An Internet-based approach lends itself to more varied, complex, and elegant expedients. If the user connects her PC to the vendor's Internet site, a more service-bureau type of approach is available.

Particular different images of additional harmful objects can be vended by Internet means—particularly those such as the previously described animated graphics files of clubs or knives and of exploding heaps of toxic powder. Such images can also be made available on a fee-per-use basis. Internet and service-bureau implementations also lend themselves to customized effects not otherwise feasible for most users. For example, software now exists that permits combination of image files—one person's head on another person's body. This permits combining a custom head (i.e., an image of the second person) with an already animated graphics file of a body. Thus, a user may send a jpeg or gif of her ex-husband's head and/or entire body to the vendor via Internet; the vendor may then send back an animated graphics file that causes an image 10 of the ex-husband to appear to be stabbing himself in the stomach or otherwise being injured. This technique permits apparent changes (such as alterations or mutilations, or loss, of body parts) to occur as a result of the aggressive actions performed virtually against the second person. In an extreme case, the returned image might show the ex-husband simulating Oedipus by sticking a sharp object into his eyes and bleeding copiously, thereby providing classical catharsis to the ex-wife without any actual harm coming to the ex-husband, while at the same time the ex-wife suffers no conscious guilt or legal liability to which causing actions in actual, rather than virtual, space would expose her. Similarly, expedients may advantageously be employed such as that of an animated representation of a pit bull chewing on a body part of the second person or of a bear disemboweling him. Other forms of mayhem simulation will be obvious to those skilled in the art, for example, as suggested by the celebrated case of Commonwealth v. Bobbitt, No. 93-CR-33821 (Cir. Ct. Va., filed Aug. 23, 1993). (A software programmer of ordinary skill will be aware of the sources of routines, modules, and small programs for performing the foregoing expedients and the other graphics-related functions used in the invention, so that they can readily be incorporated into the overall, larger program of the invention.)

Such seemingly extreme applications can prove especially beneficial in circumstances where the second person has caused a serious and irrevocable injury to the first person. For example, the method of the invention is advantageously adapted for use in an AIDS therapy, such as that of Example 2. It is considered that the first person's use of this method helps alleviate the feelings of anger and resentment due to this serious and irrevocable injury. Another type of serious and irrevocable injury for which such expedients may be appropriate is a case where the second person has caused the death of a third person having a special relationship to the first person (for example, killed a child of the first person). Therapy to overcome feelings of helplessness and powerlessness in cases of spousal abuse, such as Example 1, are also candidates for such expedients.

In such Internet-implemented embodiments, the computer-readable code is not preferably encoded into a computer-readable medium such as a CD (although it can be) that is then provided to the user, but rather as a computer-readable signal that is transmitted via the Internet from the vendor to the user's PC or vice-versa. (Signals may need to be transmitted in both directions, not only for payment of the vendor but for interactive aspects of the procedure.) In Internet-implemented embodiments, the method of the invention is adapted so that at least a substantial portion of at least one step is effected by transmitting a signal via the Internet from the user to the vendor or from the vendor to the user (or both).

Incantations

Further, the vendor can vend a phrase, mantra, or incantation to the user to use with the method, and can do so, for example, by Internet means. Indeed, the phrase, mantra, or incantation can be combined with appropriate computer code so that a sound system and sound file plays the phrase, mantra, or incantation audibly while the steps of the method are performed; the package of necessary code is advantageously vended as a unit by Internet means. Such a phrase, mantra, or incantation is customizable for the particular therapeutic use. For example, spousal abuse therapy is appropriately accompanied by selection of a different kind of phrase (for example, “You are not helpless! You can control your life!”) than is suited for use in therapy with regard to being dumped by a lover; in other cases the negative feelings and thoughts in question will call for still different types of language. For best therapeutic effect, such phrases should be selected so that they will help to alleviate the particular kind of negative feelings involved. For example, in a case of spousal abuse the negative feeling to be overcome are those of fear, powerlessness, vulnerability, or anger caused by spousal abuse, and the example given above (“You are not helpless! You can control your life!”) is selected for that purpose. Feelings of victimization, for example, may call for words suggesting the imminence of retribution or vengeance against the second person. Still other users may prefer phrases, mantras, or incantations in Aramaic, such as “Avada Kedavra!”whiled other users may consider Latin phrases to be more efficacious, such as “Arde in regnum phasmatis!” Customization of the phrase for a given user can involve use of the name of the second person: for example, “Take that, Greg!” or “Drop dead, Alex!”

When such an incantation is to be used, the computer program controlling the PC must utilize and/or include hardware and software components for causing an audible recitation or rendition of the incantation that a vendor has provided for this purpose (as a sound file, such as midi, rm, way, wma, or xmf), so that the recitation occurs during at least a part of the procedure. PCs typically include (or come equipped with) conventional software (e.g., RealPlayer, IrfanView) and hardware (sound cards and speakers) for playing music, which is advantageously put to this use. The foregoing incantation unit can either cause recitation of the incantation automatically on screen placement of object image 16, for example, or else upon a specified user action such as a keystroke or a mouse click on a button shown on the GUI, done at a moment selected by the user.

It is considered that the cooperation between the audio performance of the incantation and the simultaneous performance of the translation of object image 16 across the screen and against second person image 10 enhances the functional impact of the simulated mayhem and makes it appear (perhaps subconsciously) more efficacious to the user. Moreover, the ability of the system of the invention (or a vendor employing it) to provide prerecorded incantations in Latin or various mysterious foreign languages provides a facility that users are typically unable to provide on their own for themselves. It is considered that these features enhance the desired therapeutic effect. Also, as previously suggested, different users' therapy needs can call for use of different, indeed, customized, phrases or incantations. A library of these can be provided along with the computer program, so that appropriate ones are available for selection by the user. Alternatively, appropriate ones for a particular user' therapy needs can be made available over the Internet.

### ILLUSTRATIVE EXAMPLES

### Example 1

Jane Doe is a victim of spousal abuse. As a result she has negative feelings such as fear, vulnerability, powerlessness, and helplessness with respect to John Doe, her abuser. Jane Doe has formed a negative cathexis with respect to John Doe.

A vendor commercially exploiting the invention sells a CD to Jane Doe or to her therapist (who can direct its use by Jane Doe in therapy). The CD is encoded with computer-readable code (a computer program and various data files) to permit the user thereof to carry out the following procedure on the user's conventional PC equipped with Windows 98 or higher. The user copies the CD to the hard disk of the PC.

A photographic image of John Doe, a jpeg obtained by use of a digital camera, is input. The program resizes the John Doe image to a predetermined size (very approximately, image height 25% to 40% of screen height) and prepares a John Doe thumbnail image. Both the resized John Doe image and the thumbnail image are stored in a subdirectory (folder), which is conveniently designated “Abusers.” (Resizing gifs and jpegs to a desired size, while retaining the aspect ratio, is a commonly available function on most standard graphics programs, such as IrfanView. Many thumbnail programs, such as ThumbsPlus, are also available.)

Another subdirectory (folder) copied to hard disk from the CD is conveniently designated “Weapons.” This folder contains jpeg or gif images of knives, clubs, rocks, pieces of broken glass, and the like, which are appropriately resized with respect to the resized John Doe image to make the relative sizes of the images appear realistic. Thus the size of a club or knife would be in realistic proportion to the size of a head or body.

Jane Doe activates the program (for example, by clicking on a button on a graphic user interface [GUI] control panel on the screen display). A menu or group of buttons appears on the screen display. A message such as “Select Abuser” appears on the screen display and the file menu of Abuser (second person) images appears as thumbnails. The user clicks on a thumbnail John Doe image and thereby selects an Abuser. The resized image of the Abuser, John Doe, now appears at the right part of the screen display as image 10 of FIG. 1. (The mechanical implementation of this portion of the system can be referred to as a person image unit. In the embodiment described hereinabove, this unit comprises portions of a computer program cooperating with portions of the PC.)

A message such as “Select Weapon” now appears on the screen display. Thumbnail images are presented showing the knives, clubs, rocks, etc. stored in the Weapons folder. Jane Doe clicks on a thumbnail image of a rock and thereby selects as image 16 of FIG. 1 an image of a rock. The full size image of the rock now appears at the left part of the screen. (This portion of the system can be referred to as an object image unit. In the embodiment described hereinabove, this unit comprises portions of a computer program cooperating with portions of the PC.)

Both images now become objects or “sprites” that are used by a computer program such as a Java applet.

A message such as “Act Now” appears on the screen display. Jane Doe moves the cursor to the image of a rock, left clicks the mouse, and drags the rock image rightward toward the image of John Doe. Jane Doe moves the cursor so that the rock appears to strike John Doe. That is, Jane translates the rock across the screen and makes the rock appear to hit John on the head. Jane may repeat the process as desired before exiting the program. (This portion of the system can be referred to as a translation unit. In the embodiment described hereinabove, this unit comprises portions of a computer program cooperating with portions of the PC.)

Jane's execution of the process is cathartic and helps lessen her feelings of fear, vulnerability, powerlessness, and helplessness with respect to John Doe.

### Example 2

Bill Smith is an AIDS patient. Bill is depressed and harbors severe feelings of resentment against Tom Brown, a former partner of Bill. Bill believes that Tom, while being knowingly HIV positive, caused Bill to contract AIDS by exposing Bill to HIV through failure to utilize appropriate protective measures to prevent such exposure to HIV during personal contact. Bill has developed a negative cathexis regarding Tom.

The procedure of Example 1 is repeated but the image from the Abusers folder is that of Tom and the image from the Weapons folder is that of an animated graphic of a knife that displaces itself longitudinally from left to right one time when activated. Bill drags the knife image to a position to the left of a part of the image of Tom. The animation sequence begins only when the user, Bill, performs some specific manual action such as pressing a return key, clicking on a button on the screen, or right-clicking the mouse. That is a means for initiating the animation, which then begins and the animated knife image appears to stab the image of Tom. Bill right-clicks (or otherwise actuates the initiating means) as many times as he desires to symbolically stab Tom. This conduct effects or facilitates a partial discharge of Bill's negative cathexis towards Tom.

### Example 3

A therapist directs a patient Mary to carry out the procedure of Example 1 or 2. After one or more virtual rock bashings or stabbings, the therapist interrogates Mary to determine whether a cathartic reaction has occurred. (The therapist may also compare Mary's before and after blood pressures.) If a substantial cathartic reaction occurs, the therapist has Mary exit the program. If not, the therapist has Mary carry out additional virtual rock bashings or stabbings.

### Example 4

Alex is angry and depressed because of Greg's conduct. Greg drove his car recklessly while under the influence of a controlled substance. Greg wrecked his car, but escaped uninjured; however, his passenger, Alex's son Jason, was killed. Greg was charged with manslaughter but merely received a year of probation.

Alex carries out the procedure of Examples 1 or 2. He completes a predetermined number (one or more) of sequences of virtual rock bashings or stabbings of Greg, a message appears on the screen display, such as “Do you feel better yet? Click on YES button or NO button.” If the user Alex clicks on the YES button, the program terminates. If the user Alex clicks on the NO button, another predetermined number of sequences of virtual rock bashings or stabbings is initiated by placing the “Act Now” message on the screen display.

### Example 5

In a variation on the procedure of Example 4, the PC is provided with a supplemental input device that automatically measures user pulse rate. Instead of asking the user Alex whether he feels better yet, the PC now periodically evaluates the measured user pulse rate input. If the user pulse rate is not lowered to a predetermined extent (for example, 5%), the program keeps looping back to “Act Now.” (This is subject to user override.)

### Example 6

Jane Doe of Example 1 (or her therapist) provides to a vendor a photograph or jpeg image of John Doe. (John Doe's image is image 10 of FIG. 1.) The vendor, using conventional techniques, prepares an animated gif, an electronic copy of which has been included with this application. (It is also available at, and can be downloaded from www.law.gwu.edu/facweb/claw/Ax2Head.gif.)

The gif is an animation of FIG. 1 in which an image 16 of an ax at the left of the screen automatically crosses the screen to an image 10 of John Doe at the right of the screen. The ax then appears to chop the top off John Doe's head, which is horizontally displaced to the right of the adjacent lower part of the head. Blood appears to flow down the head and from the ax. The gif then loops back to its first frame and the same action repeats.

The vendor provides the gif to Jane Doe (directly or via her therapist). Jane Doe views the animation several times until a determination is made that viewing the animation has had a desired (cathartic) effect. Jane Doe now stops viewing the animation. Her state of mind has been transformed so that her previous feelings of fear, powerlessness, vulnerability, and anger resulting from John Doe's spousal abuse of her have been reduced.

Other Implementations and General Operation of Invention

The specific embodiments described above are based on a PC and computer screen display, but the invention is not so limited. For example, holographic cards and similar devices already exist in which an image viewed at one angle appears different when viewed at another angle. The bird logo on a VISA credit card is an example. The District of Columbia driver's license uses a similar expedient for security purposes. It is considered uneconomical (i.e., too expensive) at this time to create for a single user a customized holographic card animation comparable to that of Example 6. With anticipated advances in holographic technology, however, it should in the future become possible to provide, at a commercially practicable cost, a generally credit card sized holographic device embodying a user-customized animation generally comparable in concept to Example 6. That would permit a therapist to provide a patient like Jane Doe with a portable holographic card that she could use inconspicuously at any time and place when feelings of anxiety occurred.

The invention is thus considered to extend more generally to any similar process or combination of elements that carries out these steps: causing an image to be visibly displayed to, or perceived by, the first person (user); this image closely resembles a specific second person who has caused the user to feel fear, anger, helplessness, vulnerability, or other negative feelings. A further step is causing another image to be visibly displayed to, or perceived by, the user. This other image is that of an object seen as potentially harmful to the second person, for example, a knife or axe. Relative motion of these images in relation to one another is caused, so that the object appears to the user to be harming the second person. This brings about the transformation of subject matter described above (whether the images are located on a computer display or any other display device). That is, the state of mind of the first person (user) is transformed by the foregoing actions so that catharsis or discharge of negative cathexis occurs to at least some extent, even though the user does not consciously believe that the actual harms depicted befall the second person. The elements of the invention, in combination and cooperating together, thus provide a means for a reduction of fear, anger, or negative thoughts or feelings, and/or a reduction of or an at least partial discharge of a negative cathexis, to which the user has become subject because of prior personal adverse interactions with the second person.

While the biochemical or other physiological mechanism of catharsis is disputed, the existence of catharsis is not seriously disputed and has been believed in, in one form or another, since at least as early as the writing of Aristotle's Poetics, and expedients for performing sympathetic magic generally or analogously related to the above described discharge of negative cathexis were believed accomplishable and have been sought to be accomplished perhaps as early as when cave men 15,000 to 20,000 years ago drew pictures on cave walls at Lascaux showing arrows being shot into edible game—although not by the means described and claimed herein. (There are important distinctions between the present invention and these expedients. Aeschylus did not intend the bloody bath episode in The Agamemnon to be utilized by Athenian women as therapy for spousal abuse, nor did it provide that function. Likewise, Sophocles did not intend Oedipus Rex as therapy for young men jealous of their fathers' relationship with their mothers. Further, Voodoo and sympathetic magic expedients are not sought or provided as mental health therapies. They are intended for use simply as “machines” for accomplishing their supposed result (manipulation of the external world), and they require users to believe in them, as pointed out, for example, in D. Morse, et al., “Psychosomatically Induced Death: Relative to Stress, Hypnosis, Mind Control, and Voodoo: Review and Possible Mechanisms,” Stress Medicine 7:213-32 (1991).)

Despite the disputes over how catharsis works, it is considered that in the context of this invention, the thought patterns of the user that constitute or are representative of anger, anxiety, fear, hostility, or other negative thoughts or feelings are transformed to user thought patterns that constitute or are representative of less anger, anxiety, fear, hostility, or other negative thoughts or feelings. Such thought patterns may be embodied electrically, biochemically, or otherwise in a manner not fully explainable in the present state of scientific knowledge. It is widely accepted that memories and other thought patterns are embodied in electric and chemical signals that circulate or are transmitted from place to place within the human brain. Indeed, a considerable body of information exists on how different forms of mental activity can be imaged on electronic brain scan displays, and how changes in such activity upon occurrence of certain stimuli or mental activities can be viewed on such brain scan displays. See, e.g., M. S. George et al., “Advances in Brain Imaging: An Overview of What the Primary Psychiatrist Needs to Know,” available on line at http://www.musc.edu/psychiatry/fnrd/primer_overview.htm. It is thus considered that the operation of the invention causes one set of such signals within the brain to be transformed into a different set of such signals, where the first set is representative of one physical state (characterized, for example, by fear or anger based on memories of prior experiences) and the second set is representative of a different physical state (characterized, for example, by a reduction in such fear or anger).

The invention thus achieves the desirable objectives of providing an inexpensive, mass-marketable expedient for achieving catharsis with respect to a specific, individual person toward whom a user has anger, fear, or other negative thoughts or feelings, and/or for focusing and bringing out into the open such feelings so as to help dissipate them. The expedient of the invention is not illegal as are, for example, actual assault and battery. The user is not required to believe consciously that her catharsis-providing actions do in fact cause physical harm to the object of the negative feelings, and the object of the negative feelings need not be so persuaded either. This advantageously avoids producing feelings of guilt in the user or risks of liability, which creating such belief by engaging in actual physical acts could cause. Moreover, the difficulty is obviated that it is likely that neither the user nor object of the feelings could readily be so persuaded. The invention thus avoids or overcomes those shortcomings of analogous traditional Voodoo or shamanistic practices and of actual physical retaliation.

### CONCLUDING REMARKS

While the invention has been described in connection with specific and preferred embodiments thereof, it is capable of further modifications without departing from the spirit and scope of the invention. This application is intended to cover all variations, uses, or adaptations of the invention, following, in general, the principles of the invention and including such departures from the present disclosure as come within known or customary practice within the art to which the invention pertains, or as are obvious to persons skilled in the art, at the time the departure is made.

It should be appreciated that the scope of this invention is not limited to the detailed description of the invention hereinabove, which is intended merely to be illustrative, but rather comprehends the subject matter defined by the following claims.

As used in the specification and claims:

The term “image” means a likeness or representation of a person, animal or thing. The term includes pictorial images such as those capable of being embodied in a graphics file (jpeg, gif, png, bmp, ico, ani, etc.) of a photograph, drawing, or other picture. References to providing, accepting, or selecting an image (and like expressions) refer to providing, selecting, etc. such a graphics file (such as a jpeg or gif), or a signal or machine-readable medium embodying or representative of such a file; or providing, selecting, etc. something from which the subject matter of the image can be perceived, reproduced, or communicated.

The term “display” is usually used herein as a verb, but it is not so restricted and is used at times herein as a noun, and while a display device includes a computer display (e.g., CRT) the term “display device” is not so restricted and just requires that a device is used that causes the images to be displayed to or perceived by the user.

The term “processing unit” includes microprocessor, microcontroller, and personal computer. The terms “image unit,” “determination unit,” and “translation unit” include hardware and/or software components.

1-14. (canceled)

15. A method for treating severe feelings of victimization in a first person whom a second person recklessly or intentionally infected with HIV, said method comprising the steps of:
(1) selecting for treatment a first person having an initial level of feelings of severe victimization by a second person and desiring treatment to reduce said initial level of feelings,
said victimization comprising being infected with AIDS by a second person who, while knowingly being HIV positive, caused said infection by recklessly or intentionally failing to utilize known prophylactic measures to prevent HIV transmission during personal contact between said first person and said second person,
said initial level of feelings including or associated with a knowledge of the consequences of an AIDS infection,
said initial level of feelings characterized by and correlated with an initial physiological state of said first person, said initial physiological state characterized by and correlated with an initial pulse rate of said first person when said first person is caused to think of said second person,
said feelings being caused by a set of antecedent circumstances and experiences remembrance of which has been internalized in said first person,
said antecedent circumstances and experiences comprising said victimization of said first person by said second person;
(2) causing to be visibly displayed to said first person an image of said second person closely resembling said second person, and ascertaining said initial pulse rate of said first person;
(3) causing to be visibly displayed to said first person an image of a deadly weapon distanced from said image of said second person;
(4) causing said image of a deadly weapon to touch or become located within said image of said second person in a manner such that said deadly weapon appears to harm said second person;
(5) thereby triggering, at least potentially, a functional interaction of steps (2) through (4), on the one hand, and said antecedent circumstances and experiences remembrance of which has been internalized in said first person, on the other hand, to cause said first person to undergo a bodily transformation from said initial physiological state to a second physiological state, said second physiological state being characterized by and correlated with a lower pulse rate than said initial pulse rate and by said initial level of feelings being reduced;
(6) monitoring said first person's pulse, beginning at least as early as step (2), and ascertaining whether said pulse rate has decreased below said initial pulse rate, wherein a decrease in said pulse rate indicates a lessening in said level of feelings; and
(7) reiterating steps (4) through (6) until either said first person has a pulse rate at least five percent lower than said initial pulse rate or a predetermined time interval has elapsed, whichever occurs first, whereupon said reiterating steps (4) through (6) stops.

16-20. (canceled)

21. The method of claim 15 in which a physical output signal is provided as an indication that said first person has a pulse rate at least five percent lower than said initial pulse rate.

22. The method of claim 21 wherein said physical output signal is selected from the group consisting of written directions, spoken directions, audible sounds, electronic messages, visually perceptible signals, and electronic control signals.

23. The method of claim 22 wherein said physical output signal is an electronic control signal that automatically stops reiteration of steps (4) through (6).

24. A method for catharsis treatment of an abused person suffering from a negative cathexis caused by personal abuse during an abusive interpersonal relationship, said method comprising the steps of:
(1) selecting for treatment an abused person suffering from a negative cathexis,
said negative cathexis being characterized by an initial level of severe feelings of fear, anxiety, helplessness, powerlessness, or vulnerability,
said abused person desiring to receive treatment to reduce said initial level of feelings,
said negative cathexis and said feelings being caused by a set of antecedent circumstances and experiences remembrance of which have been internalized in said first person,
said antecedent circumstances and experiences comprising personal abuse of said abused person by an abuser, said abuser a second person with whom said abused person had an abusive interpersonal relationship,
said initial level of feelings being accompanied by and correlated with an initial level of a parameter value for blood pressure, pulse rate, or respiration rate,
an increased level of said parameter value being accompanied by and correlated with an increase in a person's feelings of fear, anxiety, helplessness, powerlessness, or vulnerability and a decreased level of said parameter value being accompanied by and correlated with a decrease in a person's feelings of fear, anxiety, helplessness, powerlessness, or vulnerability;
(2) beginning a treatment session with causing a display device to display visibly to said abused person:
(a) an abuser image, said abuser image comprising a true likeness of said abuser; and
(b) a weapon image, said weapon image comprising an image of an axe, knife, or other deadly weapon, said weapon image distanced from said abuser image and located at a location that is movably controllable by a physical action of said abused person;
(3) controlling by a physical action of said abused person said location of said weapon image so as to cause, responsively to said physical action of said abused person, said weapon image to move and touch or become located within said abuser image in a manner such that said deadly weapon appears visibly to harm said abusive person;
(4) potentially triggering, as a result of a functional interaction of steps (2) and (3) on the one hand, and said antecedent circumstances and experiences remembrance of which have been internalized in said first person on the other hand, a reduction of said initial level of feelings of fear, anxiety, helplessness, powerlessness, or vulnerability to a lower level of feelings of fear, anxiety, helplessness, powerlessness, or vulnerability, said lower level of feelings of fear, anxiety, helplessness, powerlessness, or vulnerability being accompanied by and correlated with a reduced level of a parameter value for blood pressure, pulse rate, or respiration rate;
(5) during and after step (2), detecting and monitoring at least one of said levels of a parameter value for blood pressure, pulse rate, or respiration rate of said abused person, and ascertaining whether said initial level of said at least one of said parameter levels has decreased, and if so to what extent; and
(6) reiterating steps (3) through (5) until said initial level of said at least one of said parameter levels has decreased by a predetermined amount, or until said treatment session is over, whichever occurs first.

25. The method of claim 24 wherein said intentional or reckless acts of said abuser comprise causing said abused person to contract AIDS by exposing said abused person to HIV through intentional or reckless failure by said abuser, while knowingly HIV positive, to utilize known prophylactic measures to prevent said abused person from being exposed to HIV during personal contact between said abused person and said abuser.

26. The method of claim 24 wherein said intentional or reckless acts of said abuser comprise spousal abuse of said abused person.

27. The method of claim 24 wherein the steps are performed under the supervision of a therapist who instructs said abused person to stop performing said physical action of step (3) if said initial level of blood pressure, pulse rate, or respiration rate has decreased by a first predetermined amount, and who instructs said abused person to continue performing said physical action of step (3) if said initial level of blood pressure, pulse rate, or respiration rate has not decreased by a second predetermined amount after a predetermined time interval.

28. The method of claim 24 wherein the detecting, monitoring, and ascertaining acts in step (5) are performed by said abused person.

29. The method of claim 28 wherein said abuser image and said weapon image are visibly displayed to said abused person as images embedded in a holographic card, said card hand-manipulable so that when a user twists said card from a first orientation to a second orientation said weapon image appears to move from a first location on said card to a second location on said card, said weapon image thereby appearing to strike said abuser image.

30. The method of claim 24 wherein said predetermined amount in step (6) is at least five percent.

31. The method of claim 24 wherein:
(a) step (5) is performed by electrical circuitry;
(b) said detecting in step (5) is performed by electrical circuitry coupled to a body part of said abused person;
(c) an electronic comparator performs the act in step (5) of ascertaining whether said initial level of said at least one of said parameter levels has decreased, and if so to what extent; and
(d) said comparator provides an electrical comparison signal indicative of whether said at least one of said parameter levels has decreased by a predetermined amount, and if so to what extent.

32. The method of claim 31 wherein:
(i) said abuser image and said weapon image are visibly displayed to said abused person at initially distanced location coordinates on a computer monitor screen operatively coupled to a computer, said computer associated with an input device capable of inputting to said computer a mouse-click or keystroke;
(ii) said abuser image and said weapon image are each incorporated into an animated graphics file (“animated gif”), and are each displayed on said computer monitor screen by said computer as an animation scenario in which the weapon image moves from a first location on the computer monitor screen to a second location on the computer monitor screen, the weapon thereby appearing to strike and gash the abuser's head to injure the abuser;
(iii) said physical action in step (3) comprises said abused person initiating a repeating “do until” loop of said animation scenario, by making a mouse-click or keystroke in said input device, whereupon said animation scenario begins to display repeatedly;
(iv) said electrical comparison signal of said comparator is adapted to stop said repeating “do until” loop when said at least one of said parameter levels has decreased by a predetermined amount; and
(v) said computer automatically repeats replay of said animated graphic file in accordance with step (6) until said electrical comparison signal causes said loop to stop.

33. The method of claim 24 wherein said abuser image and said weapon image are visibly displayed to said abused person at initially distanced location coordinates on a computer monitor screen operatively coupled to a computer, and said abused person controls and changes said location coordinates of said weapon image on said computer monitor screen by physically manipulating a mouse or trackball operatively coupled to said computer to cause said weapon to appear to strike said abuser.

34. The method of claim 33 wherein said weapon image is that of an axe, said axe appears to strike said abuser's head, and blood appears to spurt from said abuser's head where said axe appears to strike said head.

35. The method of claim 24 wherein said images of step (2) are jpegs or gifs and said abuser image is converted to jpeg or gif format from a photograph.

36. A method of transforming a physical state of a body of a person so as to reduce a level of feelings by said person of victimization, fear, anxiety, helplessness, powerlessness, or vulnerability caused by said person's being infected with AIDS because of another person's intentional or reckless conduct, said method comprising:
(1) selecting for treatment a first person,
said first person having a first physical state characterized by a first level of at least one physical variable,
said at least one physical variable selected from the group constituting blood pressure, pulse rate, respiration rate, and sweat secretion rate, and characterized by and correlated with a first level of feelings of victimization, fear, anxiety, helplessness, powerlessness, or vulnerability,
said feelings of said first person resulting from a set of antecedent circumstances,
said antecedent circumstances comprising a second person infecting said first person with AIDS by exposing said first person to HIV by recklessly or intentionally failing to utilize known prophylactic measures to prevent HIV transmission during personal contact between said first person and said second person,
said first person desiring to reduce said first level of feelings;
(2) predetermining a desired level of reduction of said first level of feelings, said reduction indicated by a predetermined reduction by at least five percent of said first level of said at least one physical variable;
(3) coupling to a body part of said first person a sensor for detecting a level of said at least one physical variable and providing an electronic output signal representative thereof;
(4) providing said first person with an electronic display device visibly displaying to said first person on a screen of said display device an image of a deadly weapon and, distanced therefrom on said screen, an image embodying a true likeness of said second person;
(5) electronically monitoring said output signal to detect successive levels of said at least one physical variable;
(6) causing, by a physical action of said first person, said image of a deadly weapon to touch or become located within said image of said second person in a manner such that said deadly weapon appears to harm said second person;
(7) reiterating step (6) and continuing to monitor said electronic output signal in accordance with step (5), until a functional interaction between said antecedent circumstances and reiterations of step (6) causes said first person to undergo a bodily transformation from said first physical state to a second physical state in which said electronic output signal indicates said predetermined reduction of said first level of at least one physical variable, said predetermined reduction of said first level of at least one physical variable indicating said desired level of reduction of said first level of feelings of victimization, fear, anxiety, helplessness, powerlessness, or vulnerability of said first person.

37. The method of claim 36 wherein said electronic output signal causes said electronic display device to turn off upon said electronic output signal indicating said predetermined reduction of said first level of at least one physical variable.
